(19) United States
(12) Patent Application Publication
(10) Pub. No.: US 2011/0075153 A1
(43) Pub. Date: Mar. 31, 2011

(54) Compact isolated analysis system

(76) Inventor: Josh N. Hogan, Los Altos, CA (US)

(21) Appl. No.: 12/924,316

(22) Filed: Sep. 24, 2010

Related U.S. Application Data
(60) Provisional application No. 61/277,464, filed on Sep. 25, 2009.

(51) Int. Cl. G01B 9/02; G01B 11/02

(52) U.S. Cl. 356/491; 356/497

(57) ABSTRACT

A compact OCT-like scanning device reduces radiation back-propagating to the radiation source by means of a polarized optical element that is reflective for linearly polarized light or radiation at one orientation and which is transmissive for radiation orthogonal to the reflected linearly polarized light or radiation. The device is also compatible with viewing the surface of the target being scanned either directly by visual means or by means of a camera.

### CROSS REFERENCES TO RELATED APPLICATIONS

This application, docket number FP100922US, claims priority from U.S. provisional patent application 61/277,464 (docket number JHO90810PR), and is further related to patent application Ser. No. 12/214,600, titled “Orthogonal Reference Analysis system with Enhanced SNR”, filed on Jun. 21, 2008, the entirety of both of which are incorporated herein by reference as if fully set forth herein.

### FIELD OF THE INVENTION

The invention relates to non-invasive imaging and analysis techniques such as Optical Coherence Tomography (OCT). In particular it relates to optical imaging and analysis of defects or malignant aspects of targets, such as cancer in skin or human tissue; or monitoring for possible malignancies in organs, such as the eye.

This invention also relates to non-invasive analysis of concentrations of specific components or analytes in a target, such as the concentration of glucose in blood, tissue fluids, tissue, or components of an eye or other biological entities. This invention also relates to analysis or monitoring for manufacturing defects in components for improved quality control.

### BACKGROUND OF THE INVENTION

Non-invasive analysis of targets is a valuable technique for acquiring information about systems or targets without undesirable side effects, such as damaging the target or system being analyzed. In the case of analyzing living entities, such as human tissue, undesirable side effects of invasive analysis include the risk of infection along with pain and discomfort associated with the invasive process. In the case of quality control, it enables non-destructive imaging and analysis on a routine basis, for example, for quality control purposes.

Optical coherence tomography (OCT), is a technology for non-invasive imaging and analysis. OCT typically uses a broadband optical source, such as a super-luminescent diode (SLD), to probe and analyze or image a target. It does so by applying probe radiation from the optical source to the target and interferometrically combining back-scattered probe radiation from the target with reference radiation also derived from the optical source.

The typical OCT optical output beam has a broad bandwidth and short coherence length. The OCT technique involves splitting the output beam into probe and reference beams, typically by means of a beam-splitter, such as a pellicle, a beam-splitter cube or a fiber coupler. The probe beam is applied to the system to be analyzed (the target). Light or radiation is scattered by the target, some of which is back-scattered to form a back-scattered probe beam, herein referred to as signal radiation.

The reference beam is typically reflected back to the beam-splitter by a mirror. Light scattered back from the target is combined with the reference beam, also referred to as reference radiation, by the beam-splitter to form co-propagating reference radiation and signal radiation. Because of the short coherence length only light that is scattered from a depth within the target whose optical path length is substantially equal to the path length to the reference mirror can generate a meaningful interferometric signal.

Thus the interferometric signal provides a measurement of scattering properties at a particular depth within the target. By varying the magnitude of the reference path length (by moving the reference mirror) in a conventional time domain OCT system, a measurement of the scattering values at various depths can be determined and thus the scattering value as a function of depth can be determined, i.e. the target can be scanned.

The reference radiation is typically reflected from a mirror. In addition to generating a useful interferometric signal, the reference radiation also contributes to generating noise in the detector which degrades the signal to noise ratio (SNR) and hence performance of the system. In order to optimize the SNR of typical OCT imaging and analysis systems the magnitude of the reference radiation should be arranged to be optimized for the magnitude of the back scattered optical radiation also referred to herein as the signal radiation.

This is typically achieved in conventional OCT systems by including a fixed attenuation element in the reference beam path. The magnitude of the fixed attenuator is typically selected to maximize SNR performance. This involves a compromise between having a low attenuator value to maximize the amplification of the back-scattered radiation (by having a high intensity reference level) and having a high attenuator value to minimize the detector noise associated with a high intensity reference level.

The attenuation level is typically selected as a compromise between these two competing considerations. This technique is described in the paper titled “A Simple Intensity Noise Reduction Technique for Optical Low-Coherence Reflectometry” by authors W. V. Sorin and D. M. Baney published in IEEE PHOTONICS TECHNOLOGY LETTERS, Vol. 4, No. 12, Pages 1404-1406, December 1992.

This compromise is further exacerbated in multiple reference analysis systems and frequency resolved imaging systems described in patent application Ser. No. 11/025,698 filed on Dec. 29, 2004 titled “A Multiple Reference Analysis System” and patent application Ser. No. 11/048,694 filed on Jan. 31, 2005 titled “Frequency Resolved Imaging”.

In such systems there is typically a significant portion of the reference radiation that is unwanted or valueless for signal detection and therefore only contributes to generating detector noise and hence degrades SNR.

Various techniques for minimizing the magnitude of the portion of the reference radiation that is unwanted or valueless for signal detection are described in patent application Ser. No. 11/789,278 filed on Apr. 23, 2007 titled “Optimized Reference Level Generation”. These techniques, however, add additional complexity and cost to such systems.

Furthermore, typical OCT systems use a non-polarized beam-splitter to generate probe and reference radiation. A disadvantage of this approach is that because the beam-splitter is non-polarized typically only fifty percent of the back-scattered probe radiation is directed towards the detector, thus reducing the achievable SNR of the analysis system.

Other OCT systems, such as Fourier domain OCT using either a wavelength scanning swept source or a diffraction grating (spectrometer) for wavelength separation, similarly have components of the reference radiation that are not useful for signal detection and therefore only contribute to generating detector noise. In the case of Fourier domain OCT using a diffraction grating, this further exacerbates a problematic “DC component” in the interference signal.

The analysis system described in the related patent application Ser. No. 12/214,600 titled “Orthogonal Reference Analysis System with Enhanced SNR” filed on Jun. 21, 2008, which is incorporated herein by reference, describes a method, apparatus and system for non-invasive imagining and analysis that involves generating probe radiation and reference radiation that have orthogonal polarization characteristics and controlling the polarization characteristics such that substantially all the back-scattered probe radiation co-propagates with controlled amounts of components of the reference radiation, thereby improving SNR ratios and hence performance of imaging and analysis systems.

With the above approach, there is a significant portion of the reference radiation that is unwanted or valueless for signal detection is propagated back to the radiation source. In the above approach, a significant portion of this back-propagated radiation is reflected from a partial reflecting mirror used to generate multiple reference signals.

Radiation propagating back to the radiation source can cause adverse stability issues in the source resulting in noise being generated which adversely affects the SNR performance of the above and other imaging and analysis systems. Typical approaches to preventing back-propagated radiation from interacting with the source involve in-line optical isolators which can add cost, increase system size and add alignment complexity.

There is therefore an unmet need for a method, apparatus and system that incorporates a low cost compact optical isolation technique that is compatible with a simple process of alignment.

### SUMMARY OF THE INVENTION

The invention taught herein meets at least all of the aforementioned unmet needs. The invention provides a method, apparatus and system for non-invasive imagining and analysis wherein back-propagating radiation is isolated from the radiation source in a manner that is compatible with a low-cost, compact and readily-aligned system.

Polarization characteristics that are controlled by the design of the analysis system are further exploited to enable a simple design to preferentially direct back-propagating radiation away from the optical source.

The preferred embodiment of the invention includes a Faraday rotator and a polarized optical element that is highly reflective at one polarization direction and highly transmissive at the orthogonal polarization direction. A flat polarized optical element can be used for alignment purposes and then replaced by a curved polarized optical element to focus radiation for normal operation.

The preferred embodiment of the invention also provides the ability to observe the target of the analysis system at wavelengths other than that being used for depth analysis. This can, for example, be used to facilitate lateral alignment of the analysis system.

The preferred system includes a broadband optical source, such as an SLD that, generates broadband collimated output radiation which is applied to a first polarized beam-splitter to generate linearly polarized radiation. The resulting radiation is passed through the Faraday rotator, which rotates the plane of polarization by 45 degrees, to the polarized optical element. The polarized optical element is rotationally aligned so that it reflects substantially all the radiation output from the source.

The radiation reflected back through the Faraday rotator to the first polarized beam-splitter is rotated a total of 90 degrees and is therefore reflected away from the source towards a second polarized beam-splitter, which splits the radiation into probe and reference radiation. The relative magnitude of the probe and reference radiation can be controlled by an optional half wave plate or by the rotational orientation (about the axis of the radiation beam) of the first and second polarized beam-splitters.

The reference radiation is directed through a partially reflective mirror to a rotational sensitive (or anisotropic) mirror mounted on a modulating device. Multiple reflections between the partially reflective mirror and the rotational sensitive mirror generate multiple components or orders of reference radiation. The rotational sensitive mirror systematically rotates the plane of polarization with each reflection to generate reference radiation such that larger magnitudes of higher order components pass through the second polarized beam-splitter to co-propagate with probe radiation back-scattered from the target.

The back-scattered probe radiation is rotated by 90 degrees due to the double pass through a quarter wave plate and is therefore directed by the second beam-splitter to the detection system. The co-propagating radiation comprised of signal and reference radiation is applied to a third polarized beam-splitter, oriented at 45 degrees to generate true and complementary or balanced interference signals in a pair of detectors.

Substantially all of the radiation reflected from the partially reflective mirror back towards the second polarized beam splitter is directed back towards the first polarized beam-splitter. Such back-propagating radiation will either be transmitted through the first polarized beam-splitter and thereby will not return to the source or will be directed by the first polarized beam-splitter through the Faraday rotator, which rotates it by 45 degrees thus allowing it to be transmitted through the polarized optical element and thereby isolating the source from substantially all this back-propagated radiation.

Similarly radiation components reflected from the rotational sensitive (or anisotropic) mirror or components of the back-scattered probe radiation that are directed by the second polarized beam-splitter to the first polarized beam-splitter will also either be transmitted through the first polarized beam-splitter and thereby will not return to the source or will be directed by the first polarized beam-splitter through the Faraday rotator, which rotates it by 45 degrees thus allowing it to be transmitted through the polarized optical element and thereby isolating the source from substantially all back-propagated radiation.

### BRIEF DESCRIPTION OF THE DRAWINGS

FIG. 1 is a schematic type illustration of a preferred embodiment of the analysis system according to the invention.

FIG. 2 is an illustration of a physical implementation of a preferred embodiment of the compact isolated system with the capability of observing the target.

### DETAILED DESCRIPTION OF THE INVENTION

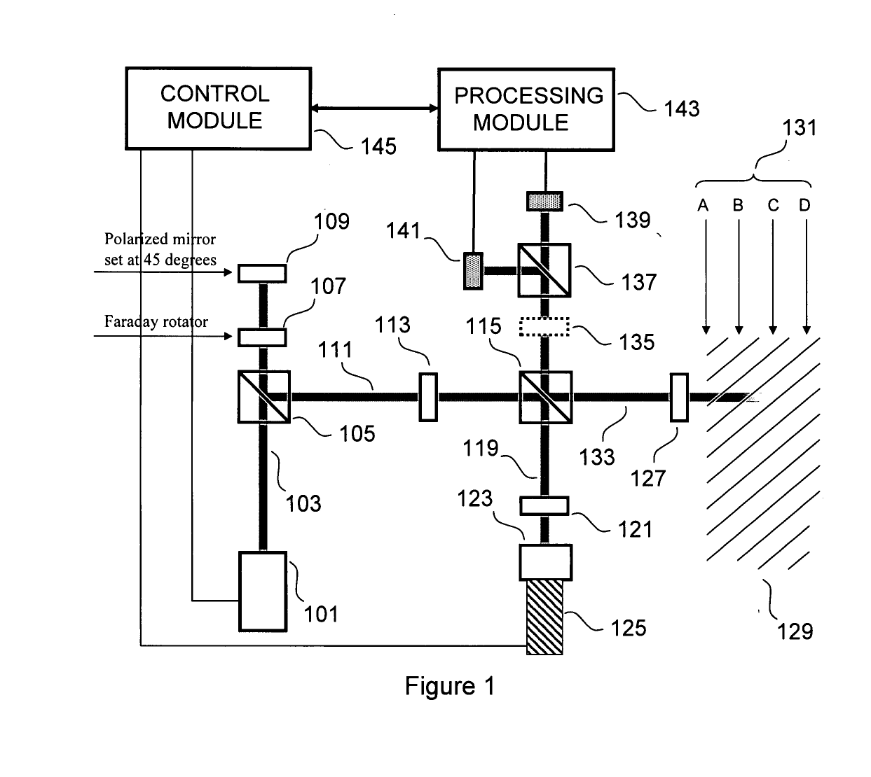

A preferred embodiment of this invention is illustrated in and described with reference to FIG. 1. The preferred embodiment includes a broadband optical source 101, that generates broadband collimated output radiation 103, referred to as source radiation, that is directed at a first polarized beam-splitter 105. The first polarized beam-splitter 105 transmits a linearly polarized component of the source radiation through a Faraday rotator 107 which rotates the linearly polarized radiation by about 45 degrees.

The rotated linearly polarized radiation is reflected by a polarized optical element 109 (which is transmissive for radiation orthogonal to this linearly polarized radiation) back through the Faraday rotator 107 which further rotates the linearly polarized radiation by about 45 degrees. The linearly polarized radiation, rotated by a total of 90 degrees is directed through an optional half wave plate 113 towards a second polarized beam-splitter 115.

This linearly polarized radiation 111 is rotated by the half wave plate 113 such that the second polarized beam-splitter 115 separates radiation into reference radiation 119 and initial probe radiation 133. The relative magnitude of reference radiation 119 and initial probe radiation 133 is determined by the orientation of the optional half wave plate 113. Alternatively, if no half wave plate is installed, the relative magnitude of reference radiation 119 and initial probe radiation 133 can be determined by the relative orientation of the first polarized beam-splitter 105 and the second polarized beam-splitter 115 (about the axis of the radiation).

As described in the patent application incorporated herein by reference, the partial reflective surface 121 and an anisotropic or rotationally sensitive mirror 123 (mounted on a piezo device 125) generate composite reference radiation, which in combination with back-scattered probe radiation can form multiple interference signals containing information related to multiple depths within the target.

The quarter wave plate 127 rotates the polarization of back-scattered probe radiation by about 90 degrees with respect to said initial probe radiation to form signal radiation that is directed by the second polarized beam-splitter 115 to a third polarized beam-splitter 137. As further described in the patent application incorporated herein by reference, this third polarized beam splitter 137 separates co-propagating composite reference radiation and signal radiation into true and complementary radiation that it directs at detectors 139 and 141 to detect complementary radiation to generate complementary interference signals, from which OCT scan information of the target is made available for processing to generate an image of at least some aspects of the target or to determine the concentration of a metabolite such as glucose.

A substantial portion of the reference radiation 119 is reflected by the partial reflective surface 121 and directed by the second polarized beam-splitter 115 back towards the first polarized beam-splitter 105. One polarization component of this back-propagating radiation will be transmitted through the first polarized beam-splitter 105 and therefore the optical source 101 is isolated from this component. As used herein back-propagating radiation describes undesired radiation propagating back through the system to the source.

The other polarization component of this back-propagating radiation will be directed by the first polarized beam-splitter 105 through the Faraday rotator 107 to the polarized optical element 109. The Faraday rotator 107 rotates this component of the linearly polarized back-propagating radiation by about 45 degrees.

The polarized optical element 109 is transmissive for this orientation of the linearly polarized orientation of this component of the linearly polarized back-propagating radiation allowing this component to be transmitted through the polarized optical element 109. Therefore the optical source 101 is isolated from this component also.

Similarly radiation components reflected from the rotational sensitive (or anisotropic) mirror 123 or components of the back-scattered probe radiation that are directed by the second polarized beam-splitter to the first polarized beam-splitter will also either be transmitted through the first polarized beam-splitter 105 and therefore will not return to the source or will be directed by the first polarized beam-splitter 105 through the Faraday rotator 107, which rotates it by 45 degrees thus allowing it to be transmitted through the polarized optical element 109 and thereby isolating the source from substantially all back-propagated radiation. In this manner substantially all radiation back-propagating to the radiation source is reduced, i.e. the radiation source is isolated.

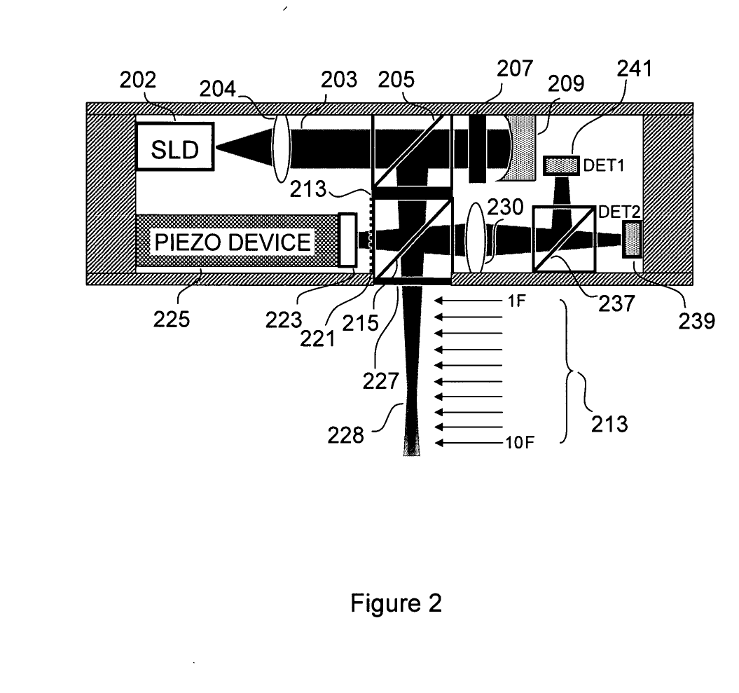

A more detailed physical implementation of a preferred embodiment of the compact OCT like scanning device is illustrated in FIG. 2. A broadband optical source 202, such as an SLD, combined with a lens 204 generates broadband collimated output radiation 203, referred to as source radiation, which is directed at a first polarized beam-splitter 205. The first polarized beam-splitter 205 transmits a linearly polarized component of the source radiation through a Faraday rotator, 207 that rotates the linearly polarized radiation by about 45 degrees.

The rotated linearly polarized radiation is reflected by a polarized optical element 209 (which is transmissive for radiation orthogonal to this linearly polarized radiation) back through the Faraday rotator 207 that further rotates the linearly polarized radiation by about 45 degrees. The linearly polarized radiation, rotated by a total of 90 degrees is directed through an optional half wave plate 213 towards a second polarized beam-splitter 215.

This linearly polarized radiation is rotated by the half wave plate 213 such that the second polarized beam-splitter 215 separates radiation into reference radiation and initial probe radiation. The relative magnitude of reference radiation and initial probe radiation is determined by the orientation of the optional half wave plate 213.

Alternatively, if no half wave plate is installed, the relative magnitude of reference radiation and initial probe radiation can be determined by the relative orientation of the first polarized beam-splitter 205 and the second polarized beam-splitter 215 (about the axis of the radiation).

As described in the patent application incorporated herein by reference, the partial reflective surface 221 and an anisotropic or rotationally sensitive mirror 223 (mounted on a piezo device 225) generate composite reference radiation, which in combination with back-scattered probe radiation can form multiple interference signals containing information related to multiple depths within the target.

The quarter wave plate 227 rotates the polarization of back-scattered probe radiation by about 90 degrees with respect to said initial probe radiation to form signal radiation that is directed by the second polarized beam-splitter 215 through a lens 230 to a third polarized beam-splitter 237.

As further described in the patent application incorporated herein by reference, this third polarized beam-splitter 237 separates co-propagating composite reference radiation and signal radiation into true and complementary radiation which it directs at detectors 239 and 241 to detect complementary radiation to generate complementary interference signals, from which OCT scan information of the target is made available for processing to generate an image of at least some aspects of the target or to determine the concentration of a metabolite such as glucose.

A substantial portion of the reference radiation is reflected by the partial reflective surface 221 and directed by the second polarized beam-splitter 215 back towards the first polarized beam-splitter 205. One polarization component of this back-propagating radiation will be transmitted through the first polarized beam-splitter 205 and therefore the optical source 202 will be isolated from this component.

The other polarization component of this back-propagating radiation will be directed by the first polarized beam-splitter 205 through the Faraday rotator 207 to the polarized optical element 209. The Faraday rotator 207 rotates this component of the linearly polarized back-propagating radiation by about 45 degrees.

The polarized optical element 209 is transmissive for this orientation of the linearly polarized orientation of this component of the linearly polarized back-propagating radiation allowing this component to be transmitted through the polarized optical element 209. Therefore the optical source 202 is isolated from this component also.

Similarly radiation components reflected from the rotational sensitive mirror 223 or components of the back-scattered probe radiation that are directed by the second polarized beam-splitter to the first polarized beam-splitter will also either be transmitted through the first polarized beam-splitter 205 and thereby will not return to the source or will be directed by the first polarized beam-splitter 205 through the Faraday rotator 207, which rotates it by 45 degrees thus allowing it to be transmitted through the polarized optical element 209 and thereby isolating the source from substantially all back-propagated radiation. In this manner substantially all radiation back-propagating to the radiation source is reduced, i.e. the radiation source is isolated.

A further valuable aspect of this compact arrangement is that by a suitable choice of optical parameters the target being scanned by the OCT-like scanner device can be viewable through the first and second beam-splitters 205 and 215. For example, a typical OCT-like depth scanning of a target such as tissue could employ a wavelength in the region of 1300 nm. Optical parameters, such as, wavelength reflectivity or transmission properties, quarter or half wave plate operation, anti-reflective coatings, polarization characteristics, etc. could be optimized for operation in the 1300 nm region while still transmitting wavelengths in the visible region from the target directly through the quarter wave plate 227, the second polarized beam-splitter 215, the half wave plate 213 and the first polarized beam-splitter 205.

This would allow the target surface to be viewed through the OCT-like scanner. This would be useful for alignment of the OCT-like scanner with respect to the target or for monitoring or inspection of the target before, during or after scanning. Such viewing could use either human vision or machine vision by means of a camera or detector array.

The preferred embodiments include an SLD however, other broadband sources could be used, (for example, a super continuum generator could be used as a source). The preferred embodiments include a collimated optical source however, various combinations of lenses or lens arrays could be employed to collimate the source radiation or to focus the probe radiation into the target or to have converging or diverging beams at the beam-splitters.

An array of optical sources, collimated by a micro-lens array could be used. The polarization optical element 209 could focus multiple beams of radiation to form an array of reference and probe radiation beams. The preferred embodiments use a piezo device to translate the rotational sensitive mirror 123 and 223 however, electro mechanical devices could also be used.

In the preferred embodiment the rotational sensitive mirror 123 and 223 could be replaced by a conventional mirror and an additional quarter wave plate could be included between the partial mirror 121 and the beam-splitter 115 of FIG. 1. (In FIG. 2 the additional quarter wave plate could be attached to the beam-splitter 215 at the partial reflective surface 221, while the surface of the quarter wave plate closest to the mirror 223 would have the partially reflective coating).

In the preferred embodiment the true and complementary signals could be separated by means other than the beam-splitter 137 and 257, such as by a birefringent element that spatially separates the polarized components. Detection of the two polarized components could be by means of a split detector.

The preferred embodiments include OCT systems using broadband optical sources and temporal scanning. Other OCT systems could be used including, but not limited to, wavelength scanning OCT systems, Fourier domain OCT systems using spectral separation and array detectors and combinations of temporal scanning, wavelength scanning and Fourier domain OCT systems. The invention could be used to isolate narrow band optical sources, such as laser diodes. The invention could also be used in optical systems other than OCT-like imaging and analysis systems, such as optical communications or optical data storage systems.

Other examples will be apparent to persons skilled in the art. The scope of this invention should be determined with reference to the specification, the drawings and the appended claims, along with the full scope of equivalents as applied thereto.

What is claimed is:

1. A device that produces radiation and reduces radiation back-propagating to the radiation source, said device comprising:
a source that generates radiation;
a polarized beam-splitter that directs a linearly polarized component of said radiation to a Faraday rotator;
a Faraday rotator that rotates said linearly polarized component of said radiation by approximately 45 degrees;
a polarized optical element that is reflective for said rotated linearly polarized component of said radiation and which is transmissive for radiation orthogonal to said rotated linearly polarized component of said radiation, such that radiation back-propagating to the source is reduced.

2. A device as in claim 1 wherein said radiation source is selected from those radiation sources suitable for OCT scanning.

3. A device for improved isolation of a radiation source, where said device reduces radiation back-propagating to the radiation source, said device comprising:
a polarized beam-splitter that directs a linearly polarized component of radiation from a radiation source to a Faraday rotator;
a Faraday rotator that rotates said linearly polarized component of said radiation by approximately 45 degrees;
a polarized optical element that is reflective for said rotated linearly polarized component of said radiation and which is transmissive for radiation orthogonal to said rotated linearly polarized radiation, such that radiation back-propagating to the source is reduced.

4. A device as in claim 3 further including a radiation source.

5. A device as in claim 4 wherein said radiation source is selected from those radiation sources suitable for OCT scanning.

6. A device as in claim 4 wherein said radiation source is selected from those radiation sources suitable for optical communications.

7. A compact OCT-like scanning device, said device comprising:
a source that generates radiation;
a first polarized beam-splitter that directs a linearly polarized component of said radiation to a Faraday rotator;
a Faraday rotator that rotates said linearly polarized component of said radiation by approximately 45 degrees;
a polarized optical element that is reflective for said rotated linearly polarized component of said radiation and which is transmissive for radiation orthogonal to said rotated linearly polarized component of said radiation;
a second polarized beam-splitter that separates radiation directed by said first polarized beam-splitter into reference radiation and initial probe radiation;
a partial reflective surface and a mirror that generate composite reference radiation;
a quarter wave plate that rotates the polarization of back-scattered probe radiation by approximately 45 degrees (resulting in an approximately 90 degrees rotation with respect to said initial probe radiation) to form signal radiation;
a detector to detect said signal radiation and output scanning results.

8. The device of claim 7 wherein the mirror is an anisotropic mirror.

9. The device of claim 7 wherein a selected relative orientation of the first polarized beam-splitter and the second polarized beam-splitter determines the relative magnitude of reference radiation and probe radiation.

10. The device of claim 7 wherein a selected orientation of a half wave plate determines the relative magnitude of reference radiation and probe radiation.

11. The device of claim 7 wherein the alignment of said first and second beam-splitters permits viewing of the target being scanned.

12. The device of claim 7 wherein said radiation source is selected from those radiation sources suitable for OCT scanning.

13. The device of claim 7 wherein said radiation source is selected from those radiation sources suitable for optical communications.

14. The device of claim 7 wherein the polarized optical element is positioned and its focal length selected so as to focus radiation into the target.

15. The device of claim 7 wherein the device further includes a processor, said processor operable to process OCT scan information of a target so as to generate an image of at least some aspects of the target.

16. The device of claim 7 wherein the device further includes a processor, said processor operable to process OCT scan information of a target so as to determine the concentration of a metabolite.

17. The device of claim 7 wherein the device further includes a processor, said processor operable to process OCT scan information of a target so as to determine the concentration of glucose.

18. The device of claim 7 further including a third polarized beam-splitter and wherein the relative orientation of said second polarized beam-splitter and said third polarized beam-splitter is selected so as to cause separation of said signal radiation into true and complementary radiation components.

19. The device of claim 7 further including a third polarized beam-splitter and a half wave plate said half wave plate positioned between said second polarized beam-splitter and said third polarized beam-splitter and wherein the relative orientation of said half wave plate is selected so as to cause separation of said signal radiation into true and complementary radiation components.

20. The device of claim 7 further including a birefringent element, said birefringent element positioned between said second polarized beam-splitter and said detector wherein said birefringent element spatially separates said signal radiation into true and complementary radiation components.
